(19) United States
(12) Patent Application Publication
(10) Pub. No.: US 2014/0095308 A1
(43) Pub. Date: Apr. 3, 2014

(54) ADVERTISEMENT DISTRIBUTION APPARATUS AND ADVERTISEMENT DISTRIBUTION METHOD

(71) Applicant: YAHOO JAPAN CORPORATION, Tokyo (JP)

(72) Inventors: Koji TSUKAMOTO, Tokyo (JP); Fukashi NAKAJIMA, Tokyo (JP); Tatsuo YAMASHITA, Tokyo (JP)

(73) Assignee: YAHOO JAPAN CORPORATION, Tokyo (JP)

(21) Appl. No.: 13/952,115

(22) Filed: Jul. 26, 2013

(30) Foreign Application Priority Data
Oct. 3, 2012 (JP) 2012-221666

(51) Int. Cl. G06Q 30/02

(52) U.S. Cl. CPC G06Q 30/0255
USPC 705/14.53

(57) ABSTRACT

A specifying unit 51 specifies a keyword from content that presents an article posted by a first user and an article posted by a second user correlated with the first user in a sequential manner. A distributing unit 52 distributes an advertisement related to the specified keyword as an advertisement to be displayed with the content.

### CROSS-REFERENCE TO RELATED APPLICATIONS

The present application claims priority to and incorporates by reference the entire contents of Japanese Patent Application No. 2012-221666 filed in Japan on Oct. 3, 2012.

### BACKGROUND OF THE INVENTION

1. Field of the Invention

The present invention relates to an advertisement distribution apparatus and an advertisement distribution method.

2. Description of the Related Art

In recent years, with the rapid spread of the Internet, the distribution of advertisements through the Internet has been actively performed. In this advertisement distribution, it is desirable to distribute advertisements of user's interest in order to obtain high advertisement effect.

Thus, a technique of specifying topic trend words (a buzzword, a trend word, and a hot trend word) to distribute advertisements related to trend words is proposed. For example, a conventional technique of acquiring a search log searched on a search site, extracting a character string of which the rate of increase in the search frequency from acquired search log as a trend word, and distributing advertisements corresponding to the trend word is proposed (for example, Japanese Patent Application Laid-open No. 2012-141682).

The conventional technique can distribute advertisements related to subjects of the general public's highest interest searched on a search site. However, it cannot be said that the subjects of the general public's interest are the subjects of high interest to each user, and there is a case where it is not possible to distribute an advertisement that appeals to each user. For example, although a user is highly interested in a subject X, the conventional technique may specify a subject Y as the subject of high interest to the general public and distribute advertisements related to the subject Y to the user.

### SUMMARY OF THE INVENTION

It is an object of the present invention to at least partially solve the problems in the conventional technology.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram schematically illustrating the configuration of a system according to a first embodiment;

FIG. 2 is a diagram illustrating an example of a functional configuration of an advertisement distribution apparatus according to the first embodiment;

FIG. 3 is a diagram illustrating a data configuration of article information according to the embodiment;

FIG. 4 is a diagram illustrating an example of a data configuration of advertisement information according to the first embodiment;

FIG. 5 is a diagram illustrating an example when an advertisement is displayed as an overlay;

FIG. 6 is a diagram illustrating an example when an advertisement is displayed as an article;

FIG. 7 is a diagram illustrating an example when an advertisement is displayed as an advertisement application included in content;

FIG. 8 is a diagram illustrating an example when an advertisement is displayed as a Web advertisement on a browser of a PC;

FIG. 9 is a flowchart illustrating the flow of an advertisement distributing process;

FIG. 10 is a diagram illustrating an example of a functional configuration of an advertisement distribution apparatus according to a second embodiment;

FIG. 11 is a diagram illustrating an example of a data configuration of user information according to the embodiment;

FIG. 12 is a diagram illustrating an example of a functional configuration of an advertisement distribution apparatus according to a third embodiment;

FIG. 13 is a diagram illustrating an example of a data configuration of keyword information according to the embodiment;

FIG. 14 is a diagram illustrating an example of a data configuration of category information according to the embodiment; and

FIG. 15 is a diagram illustrating an example of a data configuration of advertisement information according to the third embodiment.

### DETAILED DESCRIPTION OF THE PREFERRED EMBODIMENTS

Hereinafter, an advertisement distribution apparatus and an advertisement distribution method according to exemplary embodiments (hereinafter, referred to as “embodiments”) of the invention will be described in detail with reference to the drawings. The invention is not limited to the embodiments. The embodiments can be combined with each other within the range in which the content of processes is not inconsistent.

### First Embodiment

1-1. System Configuration

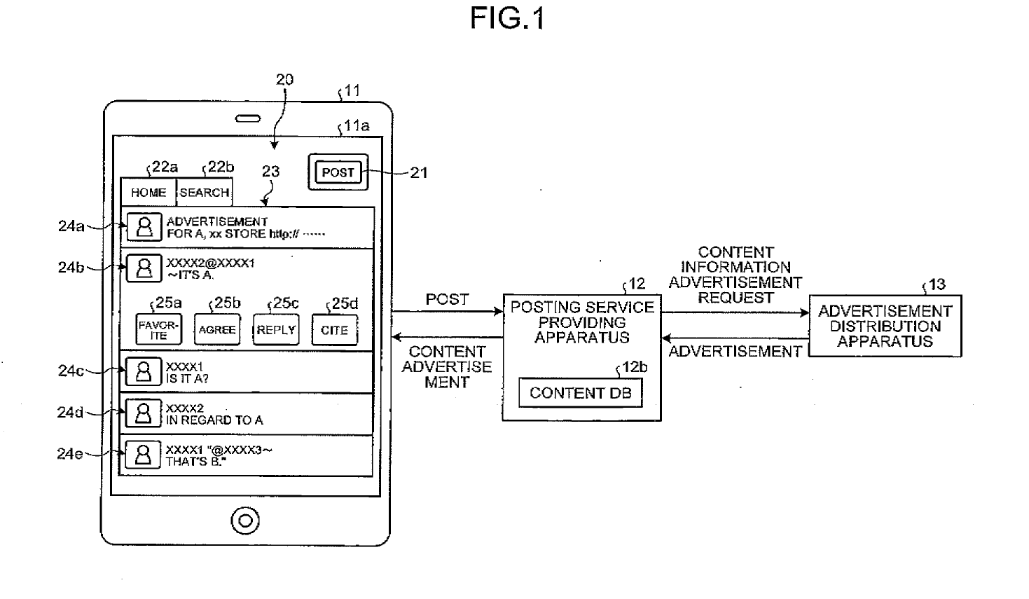

An embodiment will be described. In the embodiment, a system that specifies a subject of user's interest from an article posted on a Web posting service and distributes an advertisement related to the specified subject. FIG. 1 is a diagram schematically illustrating the configuration of a system according to the first embodiment. As illustrated in FIG. 1, a system 10 includes a user terminal 11, a posting service providing apparatus 12, and an advertisement distribution apparatus 13. The user terminal 11, the posting service providing apparatus 12, and the advertisement distribution apparatus 13 are communicably connected to one another through a network (not illustrated). Examples of the network include an optional communication network such as the Internet, a local area network (LAN), a virtual private network (VPN), or a mobile communication network regardless of whether the network is a cable network or a wireless network. In the example of FIG. 1, although a case where the system 10 includes one user terminal 11 and one posting service providing apparatus 12 is illustrated, the disclosed system is not limited to this, and the system 10 may include an optional number of user terminals 11 and an optional number of posting service providing apparatuses 12. Moreover, the system 10 may include a plurality of advertisement distribution apparatuses 13.

The user terminal 11 is a terminal device held by a user, and for example, is a smartphone, a personal digital assistant (PDA), a mobile phone, or the like. The user terminal 11 may be an information processing device such as a desktop personal computer (PC), a tablet PC, or a notebook PC. In the present embodiment, a case where the user terminal 11 is a smartphone will be described as an example.

The posting service providing apparatus 12 is an information processing apparatus such as a server computer that provides a Web posting service. The posting service providing apparatus 12 receives various requests for a Web posting service from each user via the user terminal 11. For example, the posting service providing apparatus 12 receives posting of articles from each user via the user terminal 11. The posting service providing apparatus 12 stores posted articles. The posting service providing apparatus 12 generates content that presents an article posted from each user and articles posted from another user correlated with the user in a sequential manner according to a request from each user sent from the user terminal 11 and provides the content to the user terminal 11. For example, the posting service providing apparatus 12 generates a web page that presents articles in a sequential manner on a time-line basis as content and provides the web page to the user terminal 11. Examples of such a Web posting service include Twitter (registered trademark) and Facebook (registered trademark).

The user operates the user terminal 11 to input various operation to the Web posting service. For example, a user ID and a password are assigned from the Web posting service to each user. The user logs in to the Web posting service using the user ID and the password assigned from the Web posting service.

The posting service providing apparatus 12 authenticates a user when a login request is received from the user terminal 11. Moreover, when the user is authenticated, the posting service providing apparatus 12 generates a web page that presents an article of the authenticated user and articles of the other user correlated with the user in a sequential manner and provides the web page to the user terminal 11.

The user terminal 11 receives the web page of the Web posting service provided from the posting service providing apparatus 12 and displays the received web page on a display unit 11a.

FIG. 1 illustrates an example of a screen displayed on the user terminal 11. In the example of FIG. 1, a home screen 20 displayed when a user “XXXX1” is logged in. The home screen 20 includes a post button 21 for posting an article. When the post button 21 is selected in the home screen 20, an input screen (not illustrated) for inputting an article is displayed, and the user can post an article from the input screen. Moreover, the home screen 20 includes a home tag 22a, a search tag 22b, and a timeline display region 23. The home tag 22a is a button for displaying the timeline display region 23. The timeline display region 23 is a display region in which posted articles are displayed in a sequential order.

When the search tag 22b is selected, a user search screen (not illustrated) is displayed. In the user terminal 11, a user can input a user ID and a search word in the user to perform a search to retrieve another user and designate the retrieved users as following users. Following means correlating users in order to continuously refer to articles of users designated as following users. In the user terminal 11, when a user designates another user as following users, correlation of users is performed, and articles posted by other user designated as following users are displayed on the timeline display region 23 of the user. The example of FIG. 1 illustrates a case where a user “XXXX1” designates a user “XXXX2” as a following user. In this example, articles 24c and 24d of the user “XXXX1” are displayed, and an article of the user “XXXX2” is cited by the following user and is displayed in an article 24d.

Moreover, in the timeline display region 23, an operation button is displayed so as to allow a user selects an article to perform various operation on the selected article. The example of FIG. 1 illustrates a case where a 24b is selected, and a favorite button 25a, an agree button 25b, a reply button 25c, and a cite button 25d are displayed. The favorite button 25a is a button for registering an article so as to be referenced later. The agree button 25b is a button for writing an agreement with the content of an article, and corresponds to “Like” in Facebook (registered trademark), for example. The reply button 25c is a button for posting an article as a reply to an article, and corresponds to “Reply” in Twitter (registered trademark), for example. The cite button 25d is a button for allowing another user to cite an article in his/her own timeline display region 23 to inform a follower who follows the other user, and corresponds to “Retweet” in Twitter (registered trademark), for example.

The user operates the home screen 20 displayed an the user terminal 11 to input various operation. For example, the user selects the post button 21 to post a new article. Moreover, the user selects the search tag 22b to register a user to follow. Further, the user selects the favorite button 25a to register an article as a favorite. Further, the user selects the agree button 25b to express an agreement to an article. Further, the user selects the reply button 25c to compose a reply to an article. Further, the user selects the cite button 25d to cite an article. In the example of FIG. 1, the article 24b is displayed as a reply of the user “XXXX2” to the article 24c of the user “XXXX1,” and “@XXXX1” indicates that this article is a reply to the article of the user “XXXX1.” Moreover, a article 24e cites the article of the user “XXXX3,” and the portion surrounded by quotation marks (“ . . . ”) is a cited portion.

The user terminal 11 receives various items of operation information on the home screen 20 from the user and transmits the same to the posting service providing apparatus 12.

The posting service providing apparatus 12 receives various items of operation information from the user terminal 11. For example, the posting service providing apparatus 12 receives posted articles from the user terminal 11. The posting service providing apparatus 12 stores various items of information used in the Web posting service as a content database (DB) 12b. The posting service providing apparatus 12 updates the content DB 12b based on various items of operation information received from the user terminal 11. Moreover, the posting service providing apparatus 12 generates content that presents articles based on the updated content DB 12b in a sequential manner on a timeline basis and provides the content to the user terminal 11.

Here, the posting service providing apparatus 12 is configured to be capable of include an advertisement in content to be provided. The posting service providing apparatus 12 transmits various items of information on content to the advertisement distribution apparatus 13 on an as-needed basis. For example, the posting service providing apparatus 12 transmits information on an article posted on content of each user and operation information on the content to the advertisement distribution apparatus 13. Examples of the information on the article include a user ID of content in which an article is displayed, an identification code of the article, a user ID of a user who posted the article, a posting date, and content information of content. Moreover, as the operation information on content, an identification code of an article on which any one of the favorite button 25a, the agree button 25b, the reply button 25c, and the cite button 25d is selected and information indicating which one of the favorite button 25a, the agree button 25b, the reply button 25c, and the cite button 25d is selected are transmitted, for example. Moreover, the posting service providing apparatus 12 transmits a distribution request for an advertisement to be included in content to the advertisement distribution apparatus 13. For example, the posting service providing apparatus 12 sets a user ID of content to which an advertisement is included and transmits a distribution request for an advertisement to the advertisement distribution apparatus 13.

The advertisement distribution apparatus 13 stores article information described later based on the information on an article posted on content of each user and the operation information on the content transmitted from the posting service providing apparatus 12. Moreover, upon receiving the advertisement distribution request from the posting service providing apparatus 12, the advertisement distribution apparatus 13 specifies keywords from content to which an advertisement is requested to be distributed based on the stored article information. For example, in the example of FIG. 1, “A” is specified as a keyword from the article displayed in the timeline display region 23. Moreover, the advertisement distribution apparatus 13 distributes advertisements related to the keyword to the posting service providing apparatus 12.

The posting service providing apparatus 12 includes the advertisements distributed from the advertisement distribution apparatus 13 in content to be provided and provides the content to the user terminal 11. The example of FIG. 1 illustrates a case where an advertisement is included in the content as an article. In a article 24a, “For A, xx store” is displayed as an advertisement, and a link to “xx store” is displayed.

In this manner, the posting service providing apparatus 12 specifies a keyword from content that presents an article posted by a user and an article posted by another user correlated with the user in a sequential manner. Moreover, the posting service providing apparatus 12 distributes an advertisement related to the specified keyword as an advertisement to be displayed with the content. In this way, the posting service providing apparatus 12 can distribute an advertisement of each user's interest.

1-2. Configuration of Advertisement Distribution Apparatus

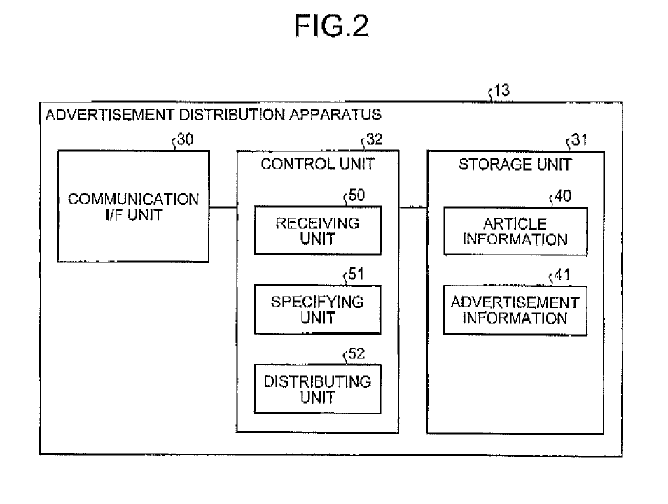

Next, the advertisement distribution apparatus 13 according to the first embodiment will be described in further detail. FIG. 2 is a diagram illustrating an example of a functional configuration of the advertisement distribution apparatus according to the first embodiment.

As illustrated in FIG. 2, the advertisement distribution apparatus 13 includes a communication interface (I/F) unit 30, a storage unit 31, and a control unit 32.

The communication I/F unit 30 is an interface such as a network interface card (NIC). The communication I/F unit 30 transmits and receives various types of data to and from other devices via a network (not illustrated). For example, the communication I/F unit 30 receives various types of data such as information on an article posted on content of each user or operation information on content from the posting service providing apparatus 12. Moreover, the communication I/F unit 30 transmits various types of data such as advertisements to the posting service providing apparatus 12.

The storage unit 31 is a device that stores various items of information. For example, examples of the storage unit 31 include a semiconductor memory device such as random access memory (RAM) or flash memory, or a storage device such as a hard disk or an optical disc, for example.

The storage unit 31 stores en operating system executed by the control unit 32 and various programs. Further, the storage unit 31 stores various items of information. For example, the storage unit 31 stores article information 40 and advertisement information 41.

The article information 40 is a table that stores information on an article posted on content. For example, in the article information 40, information on an article posted on the content of each user is stored.

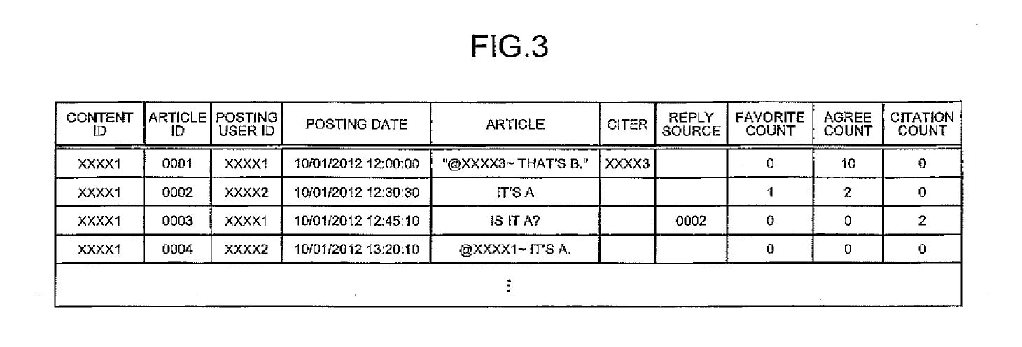

FIG. 3 is a diagram illustrating an example of a data configuration of article information according to the embodiment. The article information 40 illustrated in FIG. 3 includes regions for storing a content ID, an article ID, a posting user ID, a posting date, an article titer, a reply source, a favorite count, an agree count, a citation count, and a reply count. The content ID region is a region for storing a user ID of content on which an article is displayed. The article ID region is a region for storing en identification code for identifying en article. An identification code for identifying an article is assigned to each of posted articles. In the article ID region, the identification code assigned to each article is stored. The posting user ID region is a region for storing a user ID of a user who posted an article. The posting date region is a region for storing a posting date on which an article was posted. The article region is a region for storing the content of a posted article. The citer region is a region for storing a user ID of content of a citer when an article is cited from content of another user. When an article is not cited from content of another user, the alter region is left blank. The reply source region is a region for storing an identification code of an article serving as a reply source when an article is posted as a reply to another article. When an article is not a reply to another article, the reply source region is left blank. The favorite count region is a region for storing the number of times an article is selected as a favorite. The agree count region is a region for storing the number of times agree is selected for an article. The citation count region is a region for storing the number of times cite is selected for an article. The reply count region is a region for storing the number of times reply is selected for an article.

The example of FIG. 3 indicates that for an article of an article ID “0001,” the user ID of content is “XXXX1,” the user ID of a user who posted the article is “XXXX1,” the posting date of the article is “2012/10/01 12:00:00,” the content of the article is ““@XXXX3˜that's B”,” the user ID of content of the citer of the article is “XXXX3,” the favorite count is “0,” the agree count is “10,” the citation count is “0,” and the reply count is “0.”

The advertisement information 41 is a table that stores various advertisements. For example, advertisements are stored in the advertisement information 41 in correlation with various keywords.

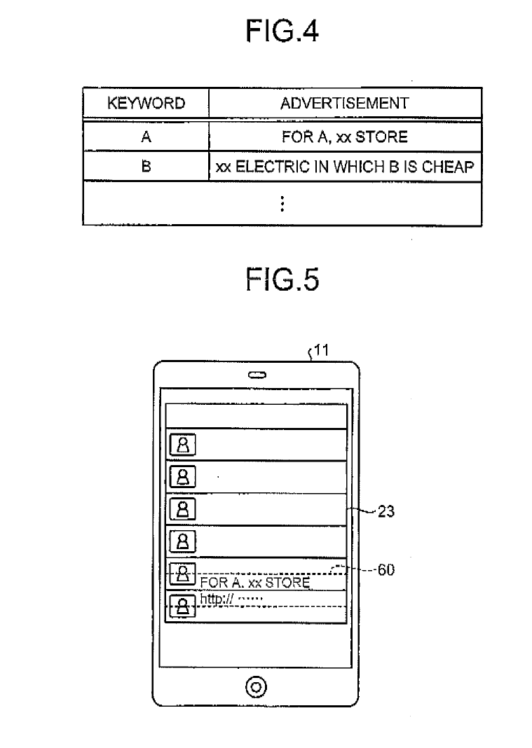

FIG. 4 is a diagram illustrating an example of a data configuration of the advertisement information according to the first embodiment. The advertisement information 41 illustrated in FIG. 4 includes regions for storing a keyword and an advertisement. The keyword region is a region for storing keywords correlated with an advertisement. The advertisement region is a region for storing the content of content to be displayed as an advertisement.

The example of FIG. 4 indicates that an advertisement “For A, xx store” is displayed in correlation with the keyword “A.”

The control unit 32 is a device that controls the advertisement distribution apparatus 13. For example, an electronic circuit such as a central processing unit (CPU) or a micro processing unit (MPU) and an integrated circuit such as an application specific integrated circuit (ASIC) or a field programmable gate array (FPGA) can be used as the control unit 32.

The control unit 32 includes programs that define various processing procedures and an internal memory for storing control data and executes various processes with the aid of the programs and the internal memory. The control unit 32 functions as various processing units according to the operation of various programs. For example, the control unit 32 includes a receiving unit 50, a specifying unit 51, and a distributing unit 52.

The receiving unit 50 receives various items of information. For example, upon receiving information on an article, the receiving unit 50 registers information on the article in the article information 40, which includes the user ID of content, the identification code for identifying the article, the user ID of a user who posted the article, the posting date, the content of content. Moreover, upon receiving the operation information on content, the receiving unit 50 counts up one of the favorite count, the agree count, the citation count, and the reply count corresponding to the selected button, of the article of the identification code based on the operation information of the content. For example, when the operation information indicates that the favorite button 25a is selected for the article of the identification code “0001,” the receiving unit 50 counts up by “1” the favorite count of the article of the identification code “0001.” Moreover, the receiving unit 50 receives an advertisement distribution request.

The specifying unit 51 specifies a keyword from content of each user based on the article information 40. A method of specifying the keyword is optional. The specifying unit 51 specifies a keyword that is the topic of each user from the content of each user as the keyword. For example, the specifying unit 51 specifies a word used frequently or a word included in an article that gained many reactions as the keyword. Upon receiving an advertisement distribution request from the receiving unit 50, for example, the specifying unit 51 reads articles of the user ID of content to which an advertisement is requested to be distributed from the article information 40. Moreover, the specifying unit 51 extracts words included in each article using an analysis technique such as morphological analysis or syntax analysis. The specifying unit 51 calculates the occurrence frequency of each word every predetermined period. The predetermined period may be a fixed period and may be set to an optional value by an administrator of the advertisement distribution apparatus 13. Moreover, the specifying unit 51 may calculate the rate of increase in the occurrence frequency of each word with respect to the previous period. Further, the specifying unit 51 may specify words of which the rate of increase in the occurrence frequency in the previous predetermined period exceeds a predetermined threshold value as the keywords. The threshold value may be a fixed value and may be set to an optional value by an administrator of the advertisement distribution apparatus 13. The specifying unit 51 may specify a word having the highest rate of increase as the keyword, for example.

With respect to each user ID, the specifying unit 51 may extract words from an article of each content of each user every predetermined period, calculate the occurrence frequency of each word, store the occurrence frequency in the storage unit 31, and upon receiving a distribution request, calculate the rate of increase in the occurrence frequency in the previous period, of each word included in the content to which an advertisement is requested to be distributed. Moreover, in the present embodiment, although a case where the rate of increase in the occurrence frequency of a word in a predetermined period has been described, the invention is not limited to this. The specifying unit 51 calculates the occurrence frequency of each word every predetermined number of nearest words. This predetermined number may be a fixed value and may be set to an optional value by an administrator of the advertisement distribution apparatus 13 or changed according to a posting interval of articles. For example, the shorter the average posting interval of articles, the larger the number is set, whereas the longer the average posting interval of articles, the smaller the number is set. Moreover, the specifying unit 51 calculates the rate of increase in the occurrence frequency of each word in a predetermined number of words appearing immediately before the word. Moreover, words of which the rate of increase in the predetermined number of words appearing immediately before the word are specified as the keywords. The specifying unit 51 may specify a word having the highest rate of increase as a keyword, for example.

Moreover, in the present embodiment, although a case where a keyword is specified based on the rate of increase in the occurrence frequency of a word has been described, the invention is not limited to this. For example, the specifying unit 51 may specify the keyword based on the number of times an article is posted from another user in relation to the article that includes the keyword. For example, the specifying unit 51 measures the number of replies to an article including each word from articles posted within a predetermined period or a predetermined number of recent articles. Moreover, the specifying unit 51 specifies words of which the measured reply count exceeds a predetermined threshold value as the keywords. The specifying unit 51 may specify a word having the highest reply count as the keyword, for example.

Moreover, for example, the specifying unit 51 may specify a keyword based on the number of other users who posted on an article that includes the keyword. For example, when the identification code of an article serving as a reply source is stored from articles posted within a predetermined period or a predetermined number of recent articles, the specifying unit 51 obtains an article serving as the reply source from the identification codes stored in the reply source. Moreover, the specifying unit 51 obtains the user ID of the user who posted an article by referring to the posting user ID of the article serving as the reply source. Moreover, the specifying unit 51 obtains the count of the user IDs of the users who posted articles that include each word as the user count by regarding the same user IDs as one user. Moreover, the specifying unit 51 specifies words of which the user count exceeds a predetermined threshold value as the keywords. The specifying unit 51 may specify a word having the highest user count as the keyword, for example.

Moreover, for example, the specifying unit 51 may specify the keywords based on the favorite count, the agree count, and the citation count of an article that includes a keyword. The specifying unit 51 measures the favorite count, the agree count, and the citation count of an article that includes each word from articles posted within a predetermined period or a predetermined number of recent articles. Moreover, the specifying unit 51 may specify the keywords based on any one or a plurality of the measured favorite count, agree count, and citation count. For example, the specifying unit 51 specifies words of which the measured count exceeds a predetermined threshold value as keywords. The specifying unit 51 may specify a word having the highest measured count as the keyword, for example. For example, when a word having the highest agree count is specified from the data illustrated in FIG. 3 as the keyword, the specifying unit 51 specifies “B” as the keyword.

Moreover, the specifying unit 51 may specify the keywords by combining the measured values of the rate of increase in the occurrence frequency of these words, the number of times articles are posted from other users in relation to an article that includes the word, and the favorite count, the agree count, and the citation count of an article that includes the word. Moreover, the specifying unit 51 may specify the keywords based on the results obtained by weighting the respective measured values with a predetermined weight. For example, the specifying unit 51 specifies words of which the result obtained by weighting each measured value with a predetermined weight exceeds a predetermined threshold value as keywords. The specifying unit 51 may specify a word having the highest weighted result as the keyword, for example.

Here, in the Web posting service, when many reactions are gained for a specific keyword, the rate of increase in the occurrence frequency of the specific keyword, the number of times articles are posted from other users in relation to an article that includes the specific keyword, the number of other users who posted an article that includes the keyword, and the favorite count, the agree count, and the citation count for the article that includes the word increase. Thus, the specifying unit 51 can specify topic trend keywords by specifying keywords using the rate of increase in the occurrence frequency of the word, the number of times articles are posted from other users in relation to an article that includes the word, the number of other users who posted an article that includes the keyword, and the favorite count, the agree count, and the citation count for the article that includes the word.

The distributing unit 52 distributes advertisements related to the specified keywords to the posting service providing apparatus 12. For example, the distributing unit 52 reads advertisements corresponding to the specified keywords from the advertisement information 41. For example, when the specified keyword is “A,” the distributing unit 52 reads “For A, xx store.” Moreover, when the specified keyword is “B,” the distributing unit 52 reads “xx electric in which B is cheap.” Moreover, the distributing unit 52 distributes the read advertisements to the posting service providing apparatus 12. In the present embodiment, although a case where advertisements corresponding to the specified keywords are distributed, the invention is not limited to this. For example, when a plurality of advertisements is distributed sequentially, the distributing unit 52 may apply a higher weight to an advertisement corresponding to a specified keyword using a score or the like so that a larger number of advertisements corresponding to the specified keyword are distributed than other advertisements.

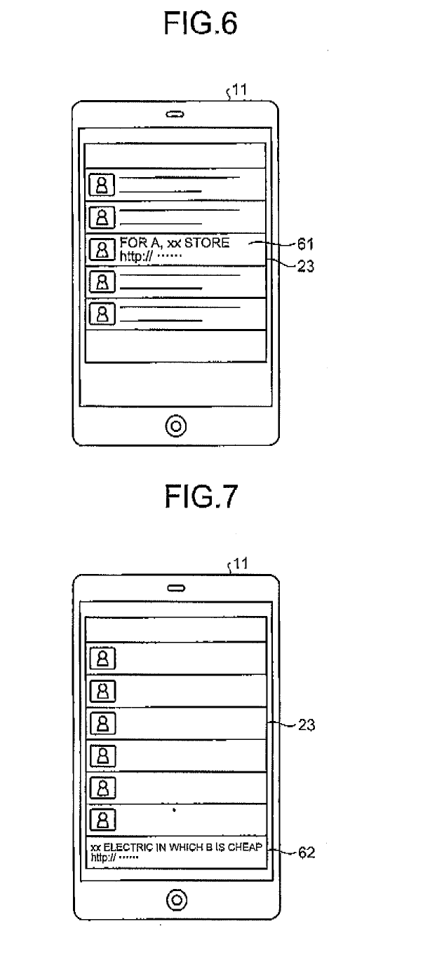

The posting service providing apparatus 12 includes advertisements distributed from the advertisement distribution apparatus 13 in content and provides the content to the user terminal 11. Here, examples of how advertisements are displayed are illustrated in FIGS. 5 to 8. FIGS. 5 and 6 illustrate a case where “A” is specified as a keyword and “For A, xx store” is distributed as an advertisement. Moreover, FIGS. 7 and 8 illustrate a case where “B” is specified as a keyword and “xx electric in which is cheap” is distributed as an advertisement. For example, when the user terminal 11 is a smartphone, the posting service providing apparatus 12 generates advertisement information that displays an advertisement as an overlay, includes the advertisement information in content, and transmits the content to the user terminal 11 so that the advertisement is displayed on the user terminal 11 as an overlay. FIG. 5 is a diagram illustrating an example when an advertisement is displayed as an overlay. As an example, an advertisement 60 is displayed on the user terminal 11 as a semitransparent layer different from the timeline display region 23. Moreover, for example, when the user terminal 11 is a smartphone, the posting service providing apparatus 12 generates advertisement information that displays an advertisement in content as an article, includes the advertisement information in the content, and transmits the content to the user terminal 11 so that the advertisement is displayed on the user terminal 11 as an article. FIG. 6 is a diagram illustrating an example when an advertisement is displayed as an article. An advertisement 61 is displayed on the display unit 11a of the user terminal 11 as an article of the timeline display region 23. However, an application developed for smartphones or the like can implement an advertisement program using a software development kit (SDK) or the like, for example. Thus, for example, when the user terminal 11 is a smartphone, the posting service providing apparatus 12 generates advertisement information for displaying an advertisement using an advertisement program included in an application and transmits the advertisement information to the user terminal 11 so that the advertisement is displayed as an article on the user terminal 11. FIG. 7 is a diagram illustrating an example when an advertisement is displayed using an advertisement program included in an application. An advertisement 62 is displayed on the display unit 11a of the user terminal 11 according to the advertisement program. On the other hand, for example, when the user terminal 11 is a PC, the posting service providing apparatus 12 generates advertisement information for displaying an advertisement on a browser of the PC as a Web advertisement and transmits the advertisement information to the user terminal 11 so that the Web advertisement is displayed on the user terminal 11. FIG. 8 is a diagram illustrating an example when an advertisement is displayed on a browser of a PC as a Web advertisement. The timeline display region 23 is displayed on a browser 75 of the user terminal 11, and an advertisement is displayed as a Web advertisement 76.

1-3. Operation

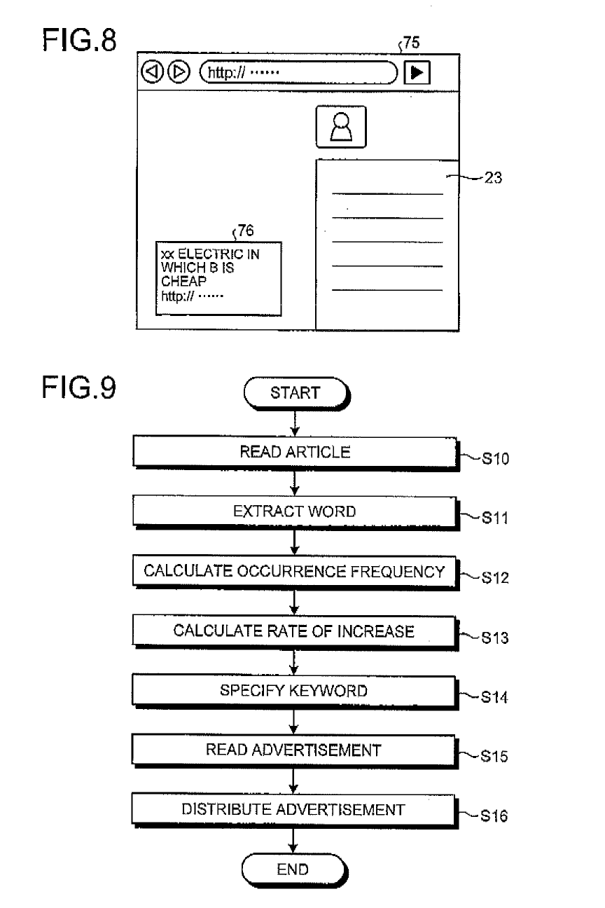

Next, the flow of an advertisement distributing process in which the advertisement distribution apparatus 13 according to the present embodiment distributes advertisements will be described. FIG. 9 is a flowchart illustrating the flow of the advertisement distributing process. The advertisement distributing process is executed at a predetermined timing, for example, when the receiving unit 50 receives an advertisement distribution request.

As illustrated in FIG. 9, the specifying unit 51 reads an article of a user ID of content to which an advertisement is requested to be distributed from the article information 40 (Step S10). The specifying unit 51 extracts words included in each article using an analysis technique such as morphological analysis or syntax analysis (Step S11). The specifying unit 51 calculates the frequency of occurrence of each word every predetermined period, for example (Step S12). Moreover, the specifying unit 51 calculates the rate of increase in the occurrence frequency of each word with respect to the previous period (Step S13). Moreover, words of which the rate of increase in the occurrence frequency in a previous predetermined period are specified as keywords (Step S14). The distributing unit 52 reads advertisements corresponding to the specified keywords from the advertisement information 41 (Step S15). Moreover, the distributing unit 52 distributes the read advertisements to the posting service providing apparatus 12 (Step S16) and terminates the process.

1-4. Effects

In this manner, the advertisement distribution apparatus 13 specifies keywords from content that presents an article posted by the user and an article posted by another user correlated with the user. Moreover, the advertisement distribution apparatus 13 distributes advertisements related to the specified keywords as advertisements to be displayed with the content. In this way, the advertisement distribution apparatus 13 can distribute advertisements of interest of each user since advertisements related to keywords specified from the content that presents the article posted by each user and the article posted by other user correlated with the user in a sequential manner are distributed to the user.

Moreover, the advertisement distribution apparatus 13 specifies keywords from articles posted within a predetermined period or a predetermined number of recent articles. In this way, the advertisement distribution apparatus 13 can specify trend keywords which are the recent topics.

### Second Embodiment

2-1. System Configuration

Next, a second embodiment will be described. The system 10 according to the second embodiment has a user terminal 11 and a posting service providing apparatus 12 that have the same configuration as the first embodiment, and description thereof will not be provided.

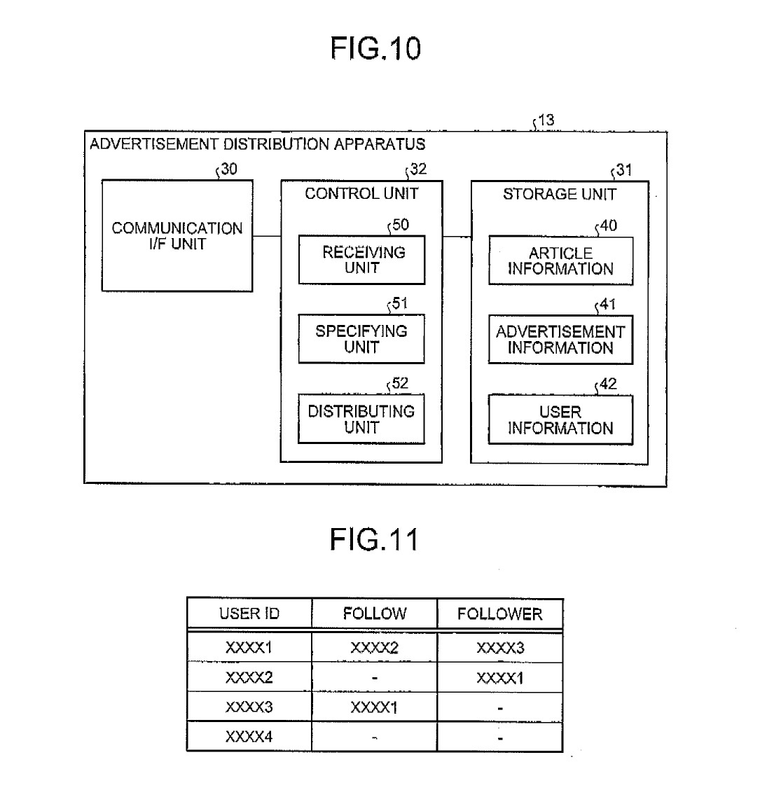

FIG. 10 is a diagram illustrating an example of a functional configuration of an advertisement distribution apparatus according to the second embodiment. The advertisement distribution apparatus 13 according to the second embodiment has approximately the same configuration as the advertisement distribution apparatus 13 according to the first embodiment illustrated in FIG. 2, and different portions will be described mainly.

As illustrated in FIG. 10, the storage unit 31 of the advertisement distribution apparatus 13 further stores user information 42.

The user information 42 is a table that stores relations between users. For example, the user information 42 stores a user followed by each user and a user who follows the user.

FIG. 11 is a diagram illustrating an example of a data configuration of the user information according to the embodiment. The user information 42 illustrated in FIG. 11 includes regions for storing a user ID, follow, and follower. The user ID region is a region for storing a user ID of a user whose relation is to be stored. The follow region is a region for storing a user ID of another user followed by the user stored in the user ID region. The follower region is a region for storing a user ID of another user who follows the user stored in the user ID region.

The example of FIG. 11 indicates that the user of the user ID “XXXX1” follows the user of the user ID “XXXX2” and is followed by the user of the user ID “XXXX3.”

The information on the relations between users stored in the user information 42 may be transmitted from the posting service providing apparatus 12 to the advertisement distribution apparatus 13. Moreover, the advertisement distribution apparatus 13 may obtain the user relation information from information on the article received from the posting service providing apparatus 12. For example, when a user follows another user, an article in which the user ID of the other user is stored in the user ID of the posting user is received as content of the user. For example, the article 24d of FIG. 1 is an article posted because the user “XXXX1” follows the user “XXXX2” since the article is not surrounded by quotation marks (“ . . . ”) and does not include “@XXXX1” that indicates a reply. For example, when a posting of another user that is neither a citation nor a reply is received as the content of the user, the receiving unit 60 registers the other user in the user information 42 as the following user of the user of the content and registers the user of the content as a follower of the other user.

The specifying unit 51 according to the present embodiment illustrated in FIG. 10 further specifies keywords from an article of content of the other user who follows an article of content to which an advertisement is requested to be distributed. For example, when an advertisement distribution request is received by the receiving unit 50, the specifying unit 51 specifies the user ID of another user who follows the user of content to which an advertisement is requested to be distributed based on the user information 42. Moreover, the specifying unit 51 reads articles of user IDs of the users followed by the user from the article information 40. Moreover, the specifying unit 51 extracts words included in each article using an analysis technique such as morphological analysis or syntax analysis and calculates the occurrence frequency of each word every predetermined period. Moreover, the specifying unit 51 calculates the rate of increase in the occurrence frequency of each word with respect to the previous period. Moreover, words of which the rate of increase in the occurrence frequency in a previous predetermined period are specified as keywords. The specifying unit 51 may specify a word having the highest rate of increase as the keyword, for example.

Moreover, the specifying unit 51 may specify the keywords by combining the measured values of the rate of increase in the occurrence frequency of the keyword appearing in an article of content of another user who follows an article of content to which an advertisement is requested to be distributed with the measured values of the rate of increase in the occurrence frequency of the words specified in the first embodiment, the number of times articles are posted from other users in relation to an article that includes the word, and the favorite count, the agree count, and the citation count of an article that includes the word. Moreover, the specifying unit 51 may specify the keywords based on the results obtained by weighting the respective measured values with a predetermined weight. For example, the specifying unit 51 specifies words of which the result obtained by weighting each measured value with a predetermined weight exceeds a predetermined threshold value as keywords. The specifying unit 51 may specify a word having the highest weighted result as the keyword, for example.

The distributing unit 52 distributes advertisements related to the specified keywords to the posting service providing apparatus 12.

2-2. Effects

In this manner, the advertisement distribution apparatus 13 specifies keywords based on any one or a plurality of the rate of increase in the occurrence frequency of a keyword in an article of the content, the rate of increase in the occurrence frequency of a keyword appearing in an article of content of another user who follows the article of the content of the user, the number of times an article was posted from another user in relation to an article that includes the keyword, the number of second users who posted on the article that includes the keyword, the number of times the article is set to a favorite by the second users, and the number of times the article that includes the keyword was agreed by the second users. In this way, the advertisement distribution apparatus 13 can specify topic trend keywords from articles that gain many reactions.

### Third Embodiment

3-1. System Configuration

Next, a third embodiment will be described. The system 10 according to the second embodiment has a user terminal 11 and a posting service providing apparatus 12 that have the same configuration as the first embodiment, and description thereof will not be provided.

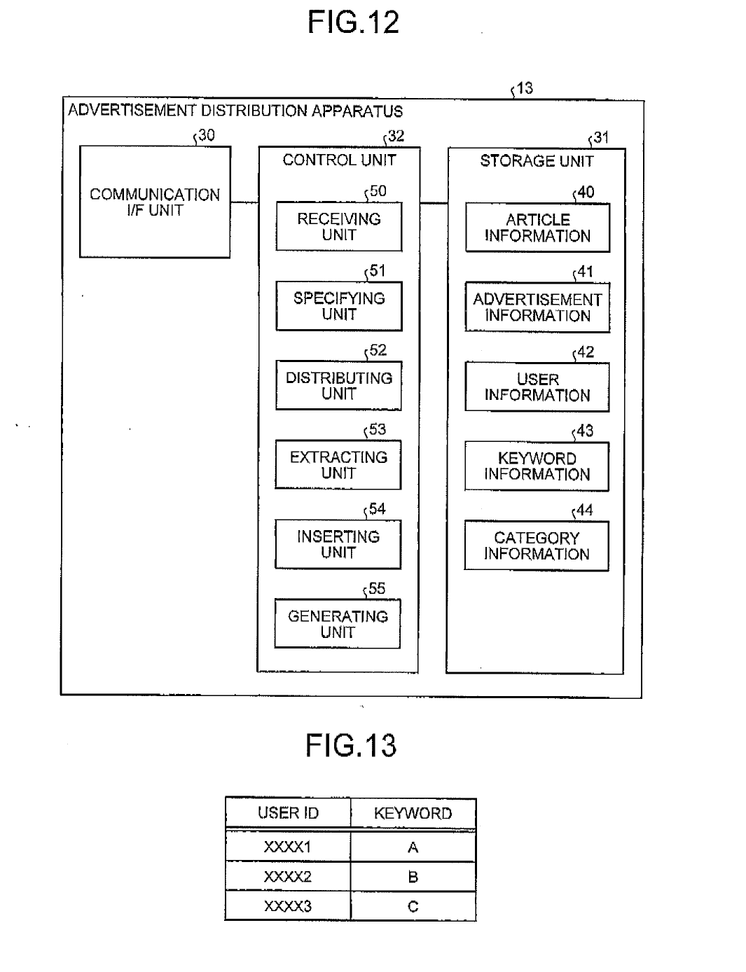

FIG. 12 is a diagram illustrating an example of a functional configuration of an advertisement distribution apparatus according to the third embodiment. The advertisement distribution apparatus 13 according to the third embodiment has approximately the same configuration as the advertisement distribution apparatus 13 according to the first and second embodiments illustrated in FIGS. 2 and 10, and different portions will be described mainly.

As illustrated in FIG. 12, the storage unit 31 of the advertisement distribution apparatus 13 further includes keyword information 43 and category information 44.

The keyword information 43 is a table that stores topic trend keywords. For example, a topic keyword of each user is stored in the keyword information 43.

FIG. 13 is a diagram illustrating an example of a data configuration of the keyword information according to the embodiment. The keyword information 43 illustrated in FIG. 13 includes regions for storing a user ID and a keyword. The user ID region is a region for storing a user ID of a user of which the keyword is to be stored. The keyword region is a region for storing a topic trend keyword in the content of the user stored in the user ID region.

The example of FIG. 13 indicates that a topic keyword of the user of the user XD “XXXX1” is “A.”

The category information 44 is a table that stores a category that classifies keywords. The keywords can be classified by categories from the meaning of each keyword. For example, when the names of various automobiles are used as keywords, the keywords can be classified as a category of automobile. The category information 44 stores keywords so as to be correlated with categories to which the keywords belong.

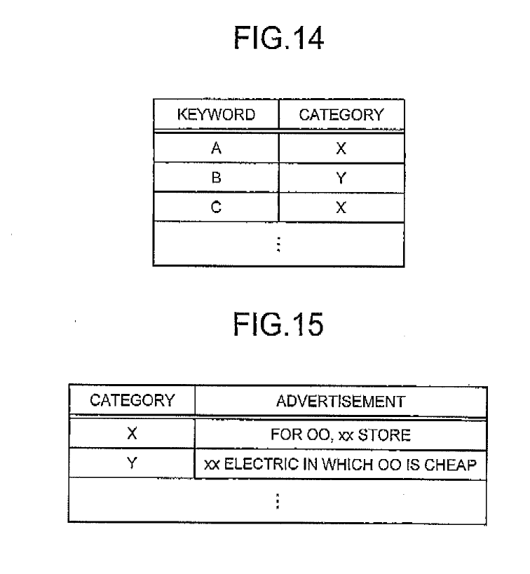

FIG. 14 is a diagram illustrating an example of a data configuration of the category information according to the embodiment. The category information 44 illustrated in FIG. 14 includes regions for storing a keyword and a category. The keyword region is a region for storing a keyword to be correlated with a category. The category region is a region for storing a category to be correlated with a keyword stored in the keyword region.

The example of FIG. 14 indicates that a keyword “A” is correlated with a category “X.”

Moreover, the advertisement information 41 according to the present embodiment stores an advertisement that includes a blank for each category.

FIG. 15 is a diagram illustrating an example of a data configuration of the advertisement information according to the third embodiment. The advertisement information 41 illustrated in FIG. 15 includes regions for storing a category and an advertisement. The category region is a region for storing a category to be correlated with an advertisement. The advertisement region is a region for storing the content of an advertisement to be displayed as an advertisement. In the example of FIG. 15, “O” indicates a blank portion of an advertisement.

The example of FIG. 15 indicates that an advertisement to be displayed in correlation with the category “X” is “For OO, xx store.” This “OO” portion is a blank portion of the advertisement.

The specifying unit 51 according to the present embodiment illustrated in FIG. 12 specifies a topic keyword of each user every predetermined period from an article posted on content of each user for the predetermined period based on the article information 40. For example, the predetermined period may be a fixed value and may be set to an optional value by an administrator of the advertisement distribution apparatus 13. Moreover, the specifying unit 51 stores the keyword specified for each user in the user information 42. In this way, the topic keyword of each user is stored in the user information 42 every predetermined period.

When an advertisement distribution request is received by the receiving unit 50, the specifying unit 51 specifies a topic keyword from the content of the user ID to which an advertisement is requested to be distributed based on the article information 40. A method of allowing the specifying unit 51 to specify keywords may be any one of the methods of the first and second embodiments. Moreover, the specifying unit 51 specifies a user correlated to the user to which an advertisement is requested to be distributed. For example, the specifying unit 51 specifies the user IDs of users related to the following users and the followers of the user ID of the user to which the advertisement is requested to be distributed. Moreover, the specifying unit 51 specifies the topic keyword corresponding to the specified user IDs of the related users from the keyword information 43.

As illustrated in FIG. 12, the control unit 32 of the advertisement distribution apparatus 13 further includes an extracting unit 53, an inserting unit 54, and a generating unit 55.

The extracting unit 53 obtains a category corresponding to the specified keyword. For example, the extracting unit 53 obtains a category corresponding to each keyword specified by the specifying unit 51 from the category information 44. Moreover, the extracting unit 53 extracts advertisement information correlated with the obtained category from the advertisement information 41. For example, when “A” is a keyword, the extracting unit 53 obtains the category “X” corresponding to the keyword “A” from the category information 44. Moreover, the extracting unit 53 extracts an advertisement “For OO, xx store” correlated with the category “X” from the advertisement information 41.

The inserting unit 54 inserts the keyword in the blanks of the extracted advertisement. For example, the inserting unit 54 inserts each keyword specified by the specifying unit 51 into the blanks of the advertisement extracted by the extracting unit 53 from each keyword. For example, the inserting unit 54 inserts the keyword “A” into the “OO” portion of the advertisement “For OO, xx store” to generate an advertisement “For A, xx store.”

The generating unit 55 generates advertisement information in such a format that the advertisement in which the keyword is inserted by the inserting unit 54 can be inserted into content. For example, the generating unit 55 generates advertisement information that displays an advertisement as an overlay, advertisement information that displays an advertisement on content as an article, advertisement information that displays an advertisement using an advertisement application included in content, and advertisement information that displays an advertisement as a web advertisement. When the posting service providing apparatus 12 transmits an advertisement distribution request to the advertisement distribution apparatus 13 by designating an advertisement format, the generating unit 55 may generate advertisement information of the designated format.

The distributing unit 52 distributes the advertisement information generated by the generating unit 55 to the posting service providing apparatus 12.

The posting service providing apparatus 12 includes the advertisement information corresponding to a display format of the user terminal 11 in content and provides the content to the user terminal 11. In this way, advertisements related to topic keywords in content of other users correlated with the user are also displayed on the user terminal 11. Moreover, advertisements related to topic keywords in the content of the user are also displayed on the user terminals 11 of the other users. Here, users correlated with each other often have similar interests. Moreover, users correlated with each other are often interested in the topics of the other users. Thus, by distributing advertisements related to topic keywords of the users correlated with each other, it is possible to distribute advertisements of the user's interest.

3-2. Effects

In this manner, the advertisement distribution apparatus 13 stores specified keywords in correlation with users. Moreover, the advertisement distribution apparatus 13 distributes advertisements related to keywords stored in correlation with a user to the user terminals 11 of the other users correlated with the user. In this way, the advertisement distribution apparatus 13 can distribute advertisements of the user's interest.

Moreover, the advertisement distribution apparatus 13 stores the category information 44 that classifies keywords by a category and the advertisement information 41 of an advertisement including blanks for each category. The advertisement distribution apparatus 13 obtains a category corresponding to the specified keyword from the category information 44 and extracts advertisement information correlated with the category from the advertisement information 41. The advertisement distribution apparatus 13 inserts the specified keyword into the blanks in the advertisement of the extracted advertisement information. Moreover, the advertisement distribution apparatus 13 distributes the advertisement in which the keyword is inserted. In this way, the advertisement distribution apparatus 13 can distribute an advertisement that matches a keyword without the need to register advertisements so as to be correlated with various keywords.

4. Others

While several embodiments of the invention have been described in detail with reference to the drawings, these embodiments are examples. The invention can be implemented in various modifications and improvements based on the knowledge of those skilled in the art including the aspect disclosed in Summary of the Invention.

For example, in the third embodiment, although a case where an advertisement related to a topic keyword in content of another user correlated with a user is displayed in content of the user has been described, the invention is not limited to this. For example, an advertisement related to a topic keyword in content of a user may be distributed to the terminal of another user who posted on an article of the content of the user. For example, the specifying unit 51 obtains an article corresponding to a reply source from an identification code stored in the reply source when the identification code of the article corresponding to the reply source is stored in the article information 40 illustrated in FIG. 3. Moreover, the specifying unit 51 obtains a user ID of another user who posted an article by referring to the posting user ID of the article corresponding to the reply source. The distributing unit 52 may distribute an advertisement related to a topic keyword in the content of a user who replied to an article when the distributing unit 52 distributes an advertisement to the user who posted the article. In this manner, the advertisement distribution apparatus 13 can distribute an advertisement related to a topic keyword in content of the user to content of another user by allowing the other user to reply to an article of the content of the user.

Moreover, in the above embodiments, although a case where various items of information such as information on an article posted on content of each user or operation information on content are transmitted from the posting service providing apparatus to the advertisement distribution apparatus 13 has been described, the invention is not limited to this. For example, the advertisement distribution apparatus 13 may access the content DE 12b of the posting service providing apparatus 12 via a network to acquire various items of information.

Moreover, in the above embodiments, although a case where an advertisement distributed from the advertisement distribution apparatus 13 is distributed to the user terminal 11 via the posting service providing apparatus 12 has been described, the invention is not limited to this. For example, the advertisement distribution apparatus 13 may distribute an advertisement directly to the user terminal 11 and display the advertisement in content.

Moreover, in the above embodiments, although a case where the system 10 is configured using the posting service providing apparatus 12 and the advertisement distribution apparatus 13 as separate apparatuses has been described, the invention is not limited to this. For example, the posting service providing apparatus 12 and the advertisement distribution apparatus 13 may be implemented as one apparatus.

The advertisement distribution apparatus 13 may be realized as a plurality of server computers, and the configuration of the advertisement distribution apparatus 13 may be flexibly changed depending on functions. For example, an external platform may be called by an API (Application Programming Interface) or network computing and then implemented.

In the claims, “unit” may be read “section,” “module,” “unit” or “circuit.” For example, a retriever may be read a retrieving unit or a retrieving circuit.

The advertisement distribution apparatus according to the invention can distribute advertisements of each user's interest.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An advertisement distribution apparatus comprising:
a specifying unit that specifies a keyword from content that presents an article posted by a first user and an article posted by a second user correlated with the first user in a sequential manner; and
a distributing unit that distributes an advertisement related to the keyword specified by the specifying unit as an advertisement to be displayed with the content.

2. The advertisement distribution apparatus according to claim 1, wherein
the specifying unit specifies the keyword based on any one or a plurality of a rate of increase in an occurrence frequency of a keyword in an article of the content, a rate of increase in an occurrence frequency of a keyword appearing in an article of content of the second user who follows the first user, the number of times an article is posted from the second user in relation to an article that includes the keyword, the number of second users who posted on the article that includes the keyword, the number of times the article is set as a favorite from the second user, and the number of times the article that includes the keyword is agreed from the second user.

3. The advertisement distribution apparatus according to claim 1, wherein
the specifying unit specifies a keyword from articles posted within a predetermined period or a predetermined number of nearest articles.

4. The advertisement distribution apparatus according to claim 1, further comprising:
a keyword storage unit that stores the keyword specified by the specifying unit in correlation with the first user, wherein
the distributing unit distributes advertisements related to the keyword stored in the keyword storage unit in correlation with the first user as the advertisement that is displayed to a terminal of the second user correlated with the first user or a terminal of the second user who posted on the article of the content of the first user.

5. The advertisement distribution apparatus according to claim 1, further comprising:
a generating unit that generates any one or a plurality of advertisement information that displays an advertisement correlated with the keyword as an overlay, advertisement information that displays the advertisement in contents as an article, and advertisement information that displays the advertisement using an advertisement program included in an application included in content, wherein
the distributing unit distributes the advertisement information generated by the generating unit.

6. The advertisement distribution apparatus according to claim 1, further comprising:
a storage unit that stores category information that classifies a keyword by a category and advertisement information of an advertisement that includes a blank for each category;
an extracting unit that obtains a category corresponding to the keyword specified by the specifying unit from the category information and extracts advertisement information correlated with the category from the storage; and
an inserting unit that inserts the keyword specified by the specifying unit into the blank of the advertisement of the advertisement information extracted by the extracting unit, wherein
the distributing unit distributes the advertisement in which the keyword is inserted by the inserting unit.

7. An advertisement distribution method executed by a computer, the method comprising:
specifying a keyword from content that presents an article posted by a first user and an article posted by a second user correlated with the first user in a sequential manner; and
distributing an advertisement related to the keyword specified in the specifying of the keyword as an advertisement to be displayed with the content.
